(19) United States
(12) Patent Application Publication
(10) Pub. No.: US 2006/0185160 A1
(43) Pub. Date: Aug. 24, 2006

(54) Access door for production machine

(75) Inventors: Rudolf Arb, Untersulmentingen (DE); Josef Bentele, Laupheim (DE); Georg Pfau, Laupheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: UHLMANN Pac-Systeme GmbH & Co. KG

(21) Appl. No.: 11/354,270

(22) Filed: Feb. 14, 2006

(30) Foreign Application Priority Data
Feb. 18, 2005 (DE) 102005007691.2

(51) Int. Cl. B23P 21/00

(52) U.S. Cl. 29/771; 29/772

(57) ABSTRACT

A production-machine door assembly has an annular frame fixed on the production machine and defining an opening through which access to its workspace is possible. A plurality of door panels in a closed position are generally coplanar and substantially cover the opening with edges of the door panels immediately juxtaposed. Respective releasable hinges at the edges pivotally connect the door panels together and are releasable to allow separation of the door panels from one another. A guide structure serves for, when at least one of the hinges is released, folding the door panels together.

### FIELD OF THE INVENTION

The present invention relates to a production machine. More particularly this invention concerns an access door for such a machine.

### BACKGROUND OF THE INVENTION

It is standard to enclose the machines along a production line to protect the product. In particular it is standard to do so in a pharmaceutical plant to prevent contamination of the medicament being made or packaged.

Since, however, it is also important to be able to get at the various production machines, the housings are provided with removable panels or doors. Such arrangements are often fairly difficult to open and, when open, do not provide access just where it is needed. Furthermore when some doors are opened, they project fairly far from the production machine and get in the way.

What is more, the doors of such machines are typically very hard to clean. When the door is opened one side is normally inaccessible, making it difficult or impossible to clean it. This is particularly the case with sliding doors, which also have the disadvantage of blocking part of the opening, even when open.

### OBJECTS OF THE INVENTION

It is therefore an object of the present invention to provide an improved door assembly for a production machine.

Another object is the provision of such an improved door assembly for a production machine that overcomes the above-given disadvantages, in particular that allows access to any region behind the doors, and that opens so that the entire area covered is clear and that the door itself can be cleaned thoroughly.

### SUMMARY OF THE INVENTION

A production-machine door assembly has according to the invention an annular frame fixed on the production machine and defining an opening through which access to its workspace is possible. A plurality of door panels in a closed position are generally coplanar and substantially cover the opening with edges of the door panels immediately juxtaposed. Respective releasable hinges at the edges pivotally connect the door panels together and are releasable to allow separation of the door panels from one another. A guide structure serves for, when at least one of the hinges is released, folding the door panels together.

Thus the door panels are pivotally and releasably hinged together at their edges. Thus they can, when pivoted together, be opened and closed like a standard multipanel folding door. When, however, they are disconnected, two of panels can be swung out for access to the region behind the disconnected edges, so that even if the door has a large number of panels, it is possible to open at any location for access to a particular region, without having to clear the entire opening. This disconnection also allows any of the panels to be swung out so both its sides are exposed and can be cleaned easily.

According to the invention the edges are all substantially parallel and define substantially parallel pivot axes for the door panels, which are rectangular. The edges and axes are vertical. Such a structure is extremely rugged and easy is to use. One of the panels according to the invention can be made of safety glass so that the workspace can be watched without opening the door.

In accordance with the invention the guide includes a lower rail fixed to the frame and extending along a lower edge of the opening and respective lower rollers carried on the door panels and riding on the lower rail. The lower rollers are at the edges of the respective door panels and rotate about horizontal axes. The guide can further include an upper rail fixed to the frame and extending along an upper edge of the opening and respective upper rollers carried on the door panels and riding on the upper rail. These upper rollers are at the edges of the respective door panels and rotate about vertical axes. In addition the upper rail defines a pair of confronting and parallel edges between which the upper rollers are captured.

Seals are provided according to the invention between the panels at the edges. In addition an annular seal in the frame extends around the opening and hermetically engages the door panels in the closed position.

As a safety feature, a switch on the frame monitors a position of the door panels. Thus the switch can turn on a light when the door is opened, or can prevent operation of the enclosed machine with the door is open.

### BRIEF DESCRIPTION OF THE DRAWING

The above and other objects, features, and advantages will become more readily apparent from the following description, reference being made to the accompanying drawing in which:

FIG. 1 is a side view of the door assembly according to the invention in fully closed condition;

FIG. 2 is a top view of the FIG. 1 door assembly;

FIG. 3 is a view like FIG. 2 but with the door opened at the center;

FIGS. 4 and 5 are top views illustrating the door opened at one end and pushed all the way to one side or the other; and

FIG. 6 is a vertical section through the door assembly in accordance with the invention.

### SPECIFIC DESCRIPTION

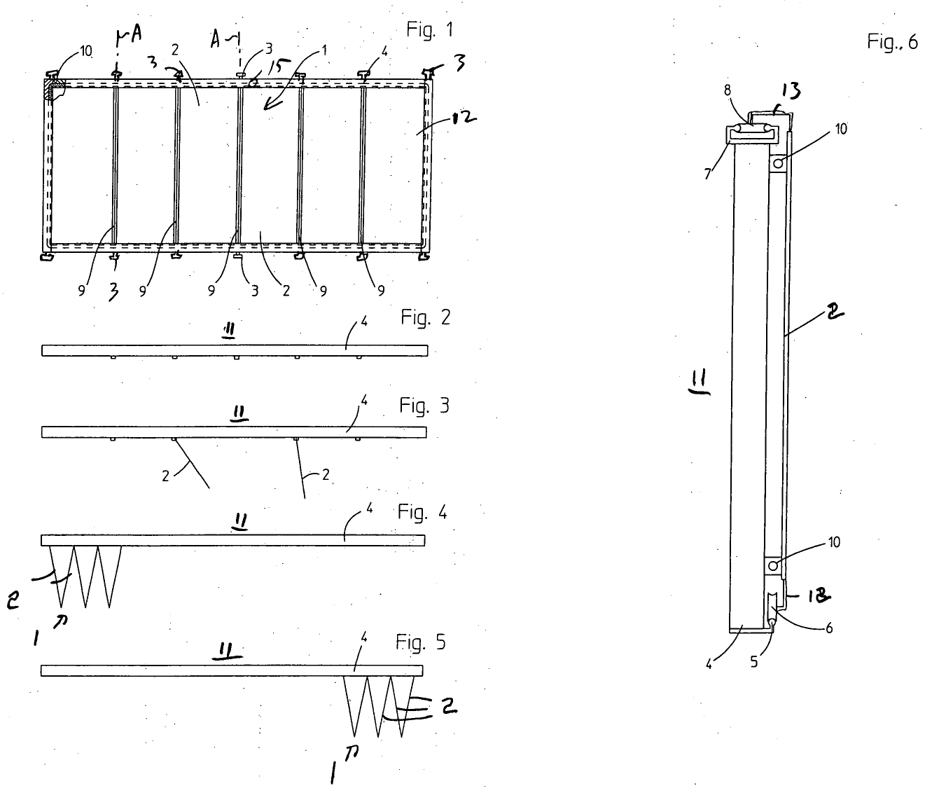

As seen in FIGS. 1-5 a door assembly 1 according to the invention is comprised of a plurality, here six, of identical stiff rectangular panels 2 that in the closed condition shown in FIGS. 1 and 2 are all substantially coplanar. The door panels 2 have vertical and parallel outside edges that are pivoted together at seals 9 and that are separable from each other by actuation of latch bolts 3. A frame 4 surrounds the door assembly 1 and defines a workspace 11 of a production machine, for instance a pill-loading station. In practice such a door assembly can be provided on each side of the production machine for access from all sides to the workspace 11.

Each of the bolts 3 is spring loaded and is permanently mounted at the hinge axis A of one panel 2 and engageable into a seat on the adjacent panel 2 so that, when the two bolts 3, which are coaxial, are pulled away from each other, they allow the respective panels 2 to separate from each other. This is shown in FIG. 3 where the center two panels 2 have been disconnected at their centrally hinged and connected edges so that they can be pivoted out and give central access to the workspace 11.

Alternately a panel 2 at the end of the assembly 1 can be actuated to separate the end panel 2 from the frame 4 and allow the entire door assembly to be swung to one side (FIG. 4) or the other (FIG. 5).

According to the invention a rail 5 extending horizontally along the lower member of the frame supports a roller 6 situated at one edge of each door panel 2, each roller 6 thus rotating about a horizontal axis perpendicular to the plane of the frame 4 and being connected via an L-shaped pivot pin 12 with the respective door edge. Similarly an upwardly open U-shaped rail 7 defines along the upper member of the frame a pair of longitudinally extending but horizontally and transversely spaced edges between which a roller 8 is captured. These rollers 8 are therefore rotatable about vertical axes at the respective door edges where they are supported on downwardly open U-shaped pivot pins 13. Thus the door panels 2 are supported at their lower ends, not hung.

FIGS. 1 and 6 also shown how a seal 10 extends peripherally around the frame 4 and bears outward on the door panels 2 in the closed positions. As mentioned, the adjacent door edges are provided with seals 9 that engage each other in the closed positions to hermetically seal the frame 4. Furthermore, a switch 15 is provided to monitor the condition of the door assembly 1, for instance only allowing a machine in the workspace 11 to start when the door assembly 1 is closed.

According to the invention one of the panels 1 can be made of safety glass, that is laminated glass with a central plastic layer that prevents the panel from shattering.

We claim:

1. In combination with a production-machine workspace, a door assembly comprising:
an annular frame fixed on the production machine and defining an opening through which access to the space is possible;
a plurality of door panels that in a closed position are generally coplanar and substantially cover the opening with edges of the door panels immediately juxtaposed;
respective releasable hinges at the edges pivotally connecting the door panels together and releasable to allow separation of the door panels from one another;
guide means for, when at least one of the hinges is released, folding the door panels together.

2. The production-machine door assembly defined in claim 1 wherein the edges are all substantially parallel and define substantially parallel pivot axes for the door panels.

3. The production-machine door assembly defined in claim 2 wherein the edges and axes are vertical.

4. The production-machine door assembly defined in claim 3 wherein the guide means includes a lower rail fixed to the frame and extending along a
lower edge of the opening; and
respective lower rollers carried on the door panels and riding on the lower rail.

5. The production-machine door assembly defined in claim 4 wherein the lower rollers are at the edges of the respective door panels and rotate about horizontal axes.

6. The production-machine door assembly defined in claim 4 wherein the guide means further includes
an upper rail fixed to the frame and extending along an upper edge of the opening; and
respective upper rollers carried on the door panels and riding on the upper rail.

7. The production-machine door assembly defined in claim 6 wherein the upper rollers are at the edges of the respective door panels and rotate about vertical axes.

8. The production-machine door assembly defined in claim 7 wherein the upper rail defines a pair of confronting and parallel edges between which the upper rollers are captured.

9. The production-machine door assembly defined in claim 1, further comprising
seals between the panels at the edges.

10. The production-machine door assembly defined in claim 1, further comprising
an annular seal in the frame extending around the opening and hermetically engaging the door panels in the closed position.

11. The production-machine door assembly defined in claim 1 wherein at least one of the panels is made of safety glass.

12. The production-machine door assembly defined in claim 1, further comprising
switch means on the frame for monitoring a position of the door panels.
